(19) United States
(12) Patent Application Publication
(10) Pub. No.: US 2008/0043570 A1
(43) Pub. Date: Feb. 21, 2008

(54) MICROMIXER

(75) Inventors: Don W. Arnold, Livermore, CA (US); Phillip H. Paul, Livermore, CA (US)

Correspondence Address: SHELDON MAK ROSE & ANDERSON PC, 100 East Corson Street, Third Floor, PASADENA, CA, 91103-3842, US

(73) Assignee: Eksigent Technologies, Inc., Dublin, CA (US)

(21) Appl. No.: 11/864,508

(22) Filed: Sep. 28, 2007

Related U.S. Application Data
(62) Division of application No. 10/845,812, filed on May 13, 2004, now abandoned.

(51) Int. Cl. B01F 13/00

(52) U.S. Cl. 366/342; 366/348

(57) ABSTRACT

Methods and apparatus for mixing fluids are provided. The devices and methods operate without moving parts, and generate well-mixed fluids over a broad dynamic range of flow rates. Preferred embodiments include junction-type mixers, bundled mixers, and co-axial mixers. The devices and methods are optimized to produce rapid, accurate gradients to improve associated system throughput and reproducibility.

### CROSS REFERENCE TO RELATED APPLICATIONS

This application is a division of application Ser. No. 10/845,812 filed May 13, 2004.

### STATEMENT REGARDING FEDERALLY SPONSORED RESEARCH OR DEVELOPMENT

Not applicable.

### BACKGROUND OF THE INVENTION

1. Field of the Invention

The invention relates to methods and apparatus for fluid mixing.

2. Description of the Related Art

Devices for mixing fluids are known in the art. In general, such devices can be characterized as active or passive fluid mixers. Active fluid mixers take advantage of mechanical or other means to provide agitation or stirring. U.S. Pat. No. 6,482,306, titled “Meso- and Microfluidic Continuous Flow and Stopped Flow Electroosmotic Mixer” describes an electroosmotic mixing device for use in meso- or microfluidic device applications. The degree of mixing provided by that disclosed device is affected by choice of materials for the chargeable surface and the ionic strength of the fluids and the type and concentration of ions in the fluids. U.S. Pat. No. 6,086,243, titled “Electrokinetic Micro-Fluid Mixer” also relies on electroosmotically induced fluid flow and so is affected by choice of charged materials used to fabricate the device as well as the ionic strength of fluids used in the device. The device described in U.S. Pat. No. 6,086,243 uses electroosmotic flow to produce repeated laminar folding that increases the interfacial area of each liquid such that diffusion of each liquid into the other takes place rapidly and leads to formation of a homogeneous mixture. The device is especially suited for mixing liquids in an environment where the velocity of liquid flow is in the range defined by a Reynolds number of less than one. The prior art also describes non electroosmotic mechanical devices that rely on fluid lamination effects to create broad areas of laminar flow where fluids traveling the same direction or speed mix via diffusion over the laminated areas. Fluid geometries are set in such devices so that flat ribbons are created to minimize the distance over which diffusion must occur. U.S. Pat. No. 6,190,034, titled “Micro-Mixer and Mixing Method” describes one such device. U.S. Pat. No. 6,457,855, titled “Micro Mixer” describes a micromixer with line connections having capillary tubes, one end of which is fitted tightly into a transverse hole, leading to a parting plane, in a housing. The other end of the capillary tubes may be fitted with screw connections to facilitate line connections.

These prior art devices fail to address the problem of providing versatile, passive, non-electroosmotic mixing devices and associated methods capable of operating over a wide variety of flow rates and fluid compositions, without introducing unnecessary axial dispersion. Such devices and methods would be advantageous for improving the overall performance of systems developed for applications such as liquid chromatography, chemical microreactors, etc. The present invention addresses these and other deficiencies of the prior art.

### SUMMARY OF THE INVENTION

The present invention is defined by the following claims, and nothing in this section should be taken as a limitation on those claims. Disclosed herein are methods and apparatus in capillary, microfluidic chip and larger conduit formats that provide effective mixing over a broad range of volumetric flow rates. The invention provides for devices and methods that achieve a high degree of mixing, have small internal volumes, short flow delay times and small blurring time. When combined with a pumping system suitable for direct pumping at the requisite flow rate, the devices and methods of the present invention allow fast chromatographic gradient generation. The short flow delay time provides for a substantial increase in gradient generation rate and thus provide for substantial increases in analytical sample throughput.

In the basic mixer, two or more flowing fluids are supplied to the inlet of conduits. The conduits can have any cross-sectional shape, but preferably are of circular cross section. The flow through the conduit and through the inputs to the conduit preferably is laminar. The length of the conduit preferably is defined as greater than about one-fourth the total flow rate through the conduit divided by the binary diffusion rate between the entering fluids. This length provides a degree of mixing at the end of the conduit approaching a value of one part in 100,000. When more than two fluids are introduced, the binary diffusion coefficient is taken as the smallest value between any two of the fluids.

Accordingly one aspect of the invention provides for a fluid mixer adapted for connection to a downstream element, comprising a conduit having an inlet, an outlet, the outlet adapted for connection to a downstream element, a length and a diameter wherein the length ranges between 1 mm and 40 cm and the diameter ranges between 25 .μm and 200 .μm, and a first and a second input, each input adapted to receive a fluid and in communication with the mixer inlet.

In another aspect, the invention provides for a system for generating and using mixed fluids, comprising a mixer of the invention in combination with a downstream element in communication with the outlet. In one embodiment, the downstream element is a sample injector, a chromatography column, a detector, a second fluid mixer, a reactant collector, a product collector, a connector, and a matrix assisted laser desorption ionization (MALDI) plate.

In yet another aspect, the invention provides for an optimized mixing device within a gradient chromatography fluid delivery system, comprising a fluid delivery source configured to deliver a plurality of fluids to the inputs of a passive mixing element, wherein the volume of the passive mixing element is less than or equal to 15 μL, and the diameter and length of the passive mixing element are selected so that during operation of the system, fluids pass through the passive mixing element and achieve greater than or equal to about 90% complete transverse mixing, or greater than or equal to about 95% complete transverse mixing, or greater than or equal to about 99% complete transverse mixing. In another embodiment, the invention provides for devices with a manifold interposed between the fluid delivery source and the passive mixing element.

In another aspect, the invention provides for a fluid mixer comprising a conduit having an inlet and an outlet, a first input comprising a first plurality of sub-conduits and adapted to receive a first fluid, a second input comprising a second plurality of sub-conduits and adapted to receive a second fluid, wherein the first plurality of sub-conduits and the second plurality of sub-conduits form a composite bundle of sub-conduits having an outlet that communicates with the conduit inlet. In one embodiment, the composite bundle is an alternating array of the first and second sub-conduits. In another embodiment, the composite bundle is an irregular array of the first and second sub-conduits.

In addition, the invention provides a device for mixing fluids comprising a mixing conduit having an inlet and an outlet, a first input conduit adapted to supply a first fluid to, co-axially oriented with respect to, and extending a distance Lₓ from the inlet end of the mixing conduit, a second input conduit adapted to supply a second fluid to and laterally oriented with respect to the mixing conduit, where for a flow rate, Q through the conduit, and a binary diffusion coefficient D of the first and second fluids to be supplied to the first and second input conduits, the mixing conduit outlet is located at a length L beyond the end of the first input conduit, and L is selected to be greater than BQ/8D, where B is a numeric factor greater than or equal to unity. A value of B=1 corresponds to a degree of mixing of about 99%, and a value of B=2 corresponds to a degree of mixing of about 99.99% while a B value greater than 2 corresponds to even higher degrees of mixing. For application to mixing in HPLC, B preferably is 2 or greater.

In other aspects, the invention provides for methods for mixing fluids by supplying fluids to the inputs of the mixers described in the above paragraphs. The invention also provides for combinations of mixing devices connected serially or in parallel.

### BRIEF DESCRIPTION OF THE SEVERAL VIEWS OF THE DRAWINGS

These and other features, aspects, and advantages of the present invention will become better understood with regard to the following description, and accompanying drawings, where:

FIG. 1 is a cross section view of a first embodiment of a mixer according to the present invention.

FIG. 2 is a cross section view of a second embodiment of a mixer according to the present invention.

FIG. 2a is a sectional view along the line I-I of FIG. 2.

FIG. 3 is a cross section view of a third embodiment of a mixer according to the present invention.

FIG. 4 is a sectional view along the line II-II of FIG. 3.

### DETAILED DESCRIPTION OF THE INVENTION

Utility and Advantages

Utility and advantages of the methods and devices of the present invention include the provision of mixing devices that have no moving parts, low cost of manufacture, rapid speed of mixing, minimized axial dispersion, broad dynamic range, and capable of damping supply pump pulsation.

### DEFINITIONS

“Adapted for connection” means configured so as to remain in fluidic communication under conditions of use.

“Detector” means any device capable of monitoring the presence of analytes or reactants, including, but not limited to, e.g., an optical fluorescence or absorption or polarization detector, a radiation detector, a microwave detector, a terahertz detector, an electrochemical detector, a mass spectrometer, an NMR spectrometer, and an ICP (induction-coupled plasma) detector.

“Degree of mixing” is the difference between the maximum and minimum concentration divided by the average concentration of either of the fluids taken over some flow cross section of a mixing conduit. Obviously the degree of mixing has a maximum value at the conduit inlet where the two fluids are segregated and for a sufficiently long conduit the degree of mixing become zero. This definition and the invention are not limited to mixing of two fluids. The extension to mixing multiple fluids is obvious to one skilled in the arts.

“Hydraulic diameter” is 4 times the cross-section area of a conduit divided by the conduit perimeter length. The cross-section of a conduit is preferably considered to be the wetted area of a conduit in a plane cut normal to the axis of the conduit. For a circular cross section, the hydraulic diameter is equal to the diameter of the circle.

### INTRODUCTION

The present invention addresses several issues that currently limit the capabilities of high performance liquid chromatography (HPLC) systems, specifically when using a method commonly known as gradient chromatography. The method requires a means for precise and controlled variation of the composition of a fluid, usually a liquid, supplied to a separation column (e.g., solvent composition is gradually changed from primarily aqueous to organic over the course of the separation). This time-variation represents a time-gradient in composition and can be in the form of a sequence of steps or a smooth function or a combination thereof. There is a continuing need to increase the throughput of chromatographic analyses (i.e., number of separations run per unit time) and thus a need to increase the speed of the gradient that can be generated. The present invention addresses this issue.

It will be appreciated by one skilled in the art that there are several factors that limit the ability to rapidly and completely mix fluids without mechanical agitation—speed of mixing, minimized dispersion, damping of supply pump pulsation, and dynamic range (of flow rates).

Speed of Mixing

Fluid (usually liquid) mixtures supplied to a separation column must be well mixed. Incomplete mixing can lead to what is termed ‘mixing noise’ which introduces a modulation on the detector output. See P. A. Miller, High Resolution Chromatography (Oxford U. Press, Oxford, 1999) pp. 38-39. This modulation obscures and interferes with the signal from chromatographic peaks, and thus limits the detection dynamic range and results in poor separation reproducibility. In current commercial HPLC devices, gradient generation is most commonly performed using one of two methods:

1) The mixture is varied at low pressure prior to pumping with a single pump,

2) Multiple pumps supply different liquids that are mixed at high pressure.

The latter method is required for high-speed gradient generation due to considerations of fluid compressibility. High-pressure mixing in HPLC systems is commonly done with both active (i.e., mechanically stirred) and static (i.e., passive) mixers. In the art, the conventional rule-of-thumb is that the volume of an active or static mixer should be 2 to 4 or 5 to 10 times the flow volume per minute, respectively. Thus, for a 1 mL/min flow rate, the flow transit time through a standard HPLC static mixer at the recommended 5 to 10 mL volume is a several minutes. There are commercially-available active HPLC mixers having a recommended residence time of about one minute. The impact on HPLC performance is clear because the cycle time for sample injection followed by gradient generation, separation and detection cannot be faster than the flow delay time through the mixer.

Dispersion/Blur:

It is well known that pressure-driven flow through a conduit produces excess axial dispersion, the so-called Taylor-Aris dispersion. This axial dispersion results in a ‘time blur’ of the gradient. For a round conduit of the prescribed length, the full-width to 1/e of this time blur is about given by one-eighth the square of the conduit diameter divided by the diffusion coefficient.

It will be appreciated by one skilled in the art of flow-induced stirring and mixing, that chaotic laminar or turbulent flow produces rapid mixing. However, in a chaotic or turbulent mixer there is an inherent spread in the transit time through the mixer. That is, any path taken by any given fluid packet through the mixer can be long or short depending upon its entrance point into the mixer; additionally, it can be trapped for some period in the mixer (e.g., within a vortex). Such a mixer acts to temporally blur (i.e., perform a conservative low pass filter) on any time variation in composition supplied to the mixer. The time-width of this blurring is on the order of the delay time through the mixer. A mixer with a one-minute flow time delay produces a temporal composition blur having a width of about one minute. Obviously, if the characteristic time of the gradient is not significantly longer than this blur time, the early portions of the gradient are mixed with the later portions of the gradient.

Supply Pump Pulsation

To some extent, all pumps used to supply fluids to the mixing region of a gradient chromatography system have an associated pulsation in the flow rate they deliver. The source of the pulsation can come from the mechanism of flow delivery (e.g., stepper motors) or from the feedback control mechanism in which the flow rate is adjusted (in response to some flow meter signal, for example). Without corrective measure, such as those described in this disclosure, the pulsations produce short time scale variations in the composition of the fluid mixture, which adversely affect the performance of a chromatography system. The important figure of merit in dealing with the pulsation issue is the time-scale of the pulsation.

Dynamic Range of a Mixing Method

In typical gradient HPLC methods, the total flow rate is held constant during the gradient and the liquid composition is varied, often from 100% of one liquid to 100% of the other liquid. The mixer preferably operates over a broad range of total flow rate as well as for the complete range of relative flow rates used for each component to be mixed. The degree of mixing preferably is uniform and all portions of the mixer preferably are well-swept by the liquids (i.e., dead/stagnant corners preferably are strictly avoided) to prevent one component from trailing and making the gradient inaccurate.

There are a number of formats now available for analytical HPLC wherein the diameter of the separation column varies from 4.6 mm down to ˜0.50 μm. Other preparative HPLC formats can have significantly larger formats (up to 10's of cm in diameter). The appropriate flow rates also varies from ˜0.1 mL/min down to ˜10 nL/min for some analytical HPLC applications, and up to 1000 mL/min for preparative applications (more typically up to 250 mL/min). In all cases, separation quality and throughput are improved by having rapid, accurate, gradients. However, mixers currently available for HPLC systems have the drawbacks mentioned throughout the range, especially at the low flow rates where active mixers are impractical.

Chemical Reactors

For chemical microreactors, there are similar requirements that are placed on mixers. The two fluid streams that contain reactants should be combined as quickly as possible to obtain the most uniform results possible, especially in situations where the reaction rates are very high or in systems where reaction kinetics measurements are being made. The mixers of the present invention also are well suited for combining and mixing fluid streams for carrying out chemical reactions.

Design and Fabrication of Mixers for Low-Flow Applications

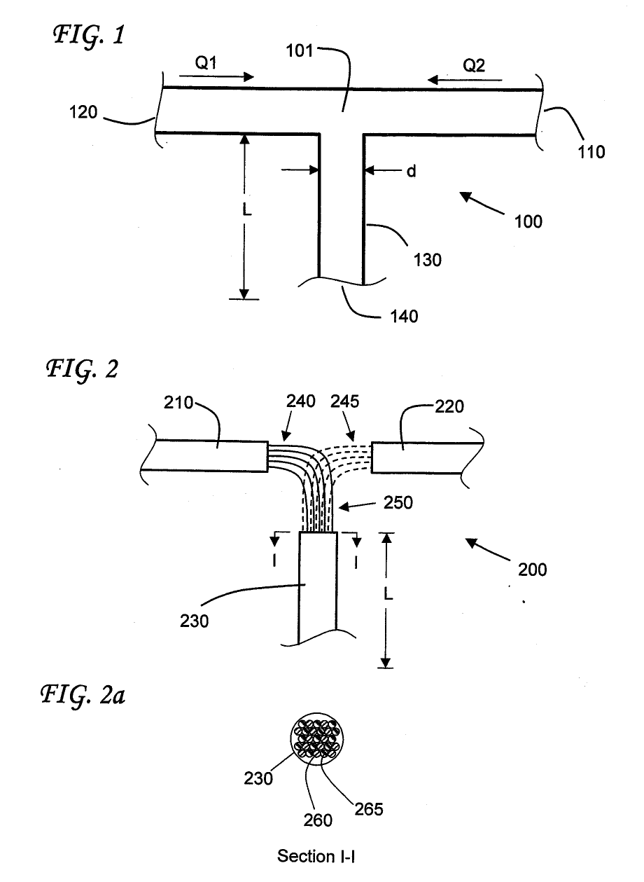

A preferred embodiment of a mixer, 100, for mixing two or more fluid streams having a combined flow rate on the order of less than about 50 μL/min is illustrated in FIG. 1. Two or more flowing fluids (usually liquids) are supplied from mixer inputs 110, 120 to the inlet, 101, of a conduit, 130. The conduit can have any cross sectional shape. Preferably the cross sectional shape is free of acute angle corners and more preferably the cross sectional is composed of obtuse angle corners and most preferably the cross sectional shape is circular. The mixer, including, the inputs and conduit, can be made of any material that is appropriate for the fluids to be mixed by the mixer. Common examples include ceramic (such as fused silica or glass), metal (such as stainless steel or copper), polymers (such as polyethyletherketone (PEEK), PTFE, polypropylene, nylon, etc.), or combinations such as fused-silica lined stainless steel or teflon-lined fused silica.

The device can be constructed from discreet components, such as tubes and connectors. Alternatively, the device can be microfabricated to take advantage of reduced dispersion that results when tubes and connectors are fully integrated.

The conduit along its length can be straight or curved, preferably any curves have a radius of curvature that is larger (preferably at least 100 time larger) than the hydraulic diameter of the conduit. The flow through the conduit and through the inputs to the conduit is preferably laminar. The length of the conduit is preferably selected to be greater than about B times one-eighth the total flow rate through the conduit divided by the binary diffusion coefficient, or BQ/8D, between the entering fluids, with B preferably greater than or equal to 2. With B set equal to 2, the corresponding length provides a degree of mixing at the end of the conduit approaching a value of one part in 100,000. When more than two fluids are introduced the binary diffusion coefficient is taken as the smallest value between any two of the fluids.

For example we consider a round conduit having a diameter d of 0.05 mm, a total flow rate Q of 10 microliters per minute and a diffusion coefficient D of 10⁻⁹ m²/s (a value typical of water diffusing into water). According to the prescription above, the length (if preferably taken to be greater than BQ/8D) is about 4.2 cm for B=2. The volume of the conduit having this length is about 0.082 microliters and the flow delay time is about 0.5 seconds. The one-on-e full width blur time is about d²/8D, which is about 0.32 seconds for this example.

To carry out successful gradient chromatography experiments, the gradient time preferably is long compared to the blur time (preferably 10 times longer and more preferably 20 to 50 times longer). The repeat cycle time preferably is longer than the delay time through the mixer and other flow components between the mixer and the column (e.g., the injection valve and any sample loop) combined with the gradient time.

For this embodiment, the length, L, of the mixing element is selected to be greater than the value of BQ/8D where Q is the flowrate and D is the diffusion coefficient.

For most HPLC applications, it is desirable to specifically to cover the range of fluids that have binary diffusion coefficient, D, values within the range of 0.5<D<4×10⁻⁹ m²/s. The range of flow rates of interest are on the order of about 0.1 μL/min up to 50 μL/min.

In the following and for purposes of illustration only, we use a value of D=1×10⁻⁹ m²/s. As one of ordinary skill will recognize, it is obvious that the results set forth below will vary with changes in the diffusion coefficient.

The length of the mixer is selected according to the relationship L=BQ/8D where B is a numerical factor greater than or equal to unity. A value of B=1 corresponds to a degree of mixing of about 99% and a value of B=2 corresponds to a degree of mixing of about 99.99% and larger values of B correspond to even high degrees of mixing. For application to mixing in HPLC a value for B of 2 or greater is preferred.

Then for example, we find:

For a flow rate of 50 uL/min, L is selected to be greater than or equal to about 10.5 cm for B=1, and is selected to be greater than about 21 cm for B=2. For a flow rate of 20 μL/min, L is selected to be greater than or equal to about 4.2 cm for B=1, and is selected to be greater than about 8.4 cm for B=2. For a flow rate of 5 μL/min, L is selected to be greater than or equal to about 1 cm for B=1 and greater than about 2 cm for B=2. For a flow rate of 0.5 μL/min, L is selected to be greater than or equal to about 0.1 cm for B=1, and greater than about 0.2 cm for B=2.

A time, T, is required for the liquid to transit the mixer. It is preferable to minimize this time, to some small fraction of the time required to perform an operation cycle such as, e.g., a chromatographic separation. The invention finds great utility under operating conditions with fast separations hence short transit times. Preferably, a mixer design is selected so that during operation, transit time through the mixer is less than about 20 seconds (i.e., T less than or equal to about 20 seconds).

The diameter, d, of the mixer is selected to be less than the value (4 Q T/L .π)^{1/2}. Substituting the relation given above for the length of the mixer yields the diameter selected to be less than (32 D T/Bπ.)^{1/2}. Then for example, we find:

For B=1:

For T=20 seconds, d is selected to be less than about 451 μm

For T=10 seconds, d is selected to be less than about 319 μm

For T=5 seconds, d is selected to be less than about 226 μm

For T=2 seconds, d is selected to be less than about 143 μm

For T=1 second, d is selected to be less than about 101 μm.

For B=2:

For T=20 seconds, d is selected to be less than about 319 μm

For T=10 seconds, d is selected to be less than about 226 μm

For T=5 seconds, d is selected to be less than about 160 μm

For T=2 seconds, d is selected to be less than about 101 μm

For T=1 second, d is selected to be less than about 71 μm.

For B=10:

For T=20 seconds, d is selected to be less than about 143 μm

For T=10 seconds, d is selected to be less than abut 101 μm

For T=5 seconds, d is selected to be less than about 71 μm

For T=2 seconds, d is selected to be less than about 45 μm

For T=1 second, d is selected to be less than about 32 μm.

Once the length and the diameter are selected the volume, V, of the mixer is fixed at V=πd²L/4.

Specific examples that are used in systems include:

For a desired flow rate of 0.5 μL/min, a desired transit time of less than about 10 seconds, L=15 cm. At this flow rate, assuming a value of 1×10⁻⁹ m²/s for the diffusion coefficient, this length corresponds to a B value=144. This configuration assists in meeting the physical requirements of spacing between the components supplying liquid to and receiving liquid from the mixer. Then according to the prescriptions above, the diameter is selected to be less than about 27 μm. It is preferable to pick a diameter less than but near equal to 27 μm (e.g. 26 μm) to minimize pressure drop through the mixer.

For a desired flow rate of 10 .μL/min, and a desired transit time of less than 1.5 seconds, L=12 cm. At this flow rate, assuming a value of 1×10⁻⁹ m²/s for the diffusion coefficient this length corresponds to a B value=5.76. Again, this facilitates meeting physical requirements of spacing between the components supplying liquid to and receiving liquid from the mixer. Then according to the prescriptions the diameter is selected to be less than about 51 μm. It is preferable to then pick a diameter less than but near equal to 51 μm (e.g. 50 μm) to minimize pressure drop through the mixer.

For a desired flow rate of 10 uL/min, with a desired B=2 and a desired transit time of less than 2 seconds, and assuming a value of 1×10⁻⁹ m.²/s for the diffusion coefficient, the length is selected to be about 4.2 cm. According to the prescriptions the diameter is selected to be less than about 101 μm. It is preferable to then pick a diameter less than but near equal to 101 μm (e.g. 100 μm) to minimize pressure drop through the mixer.

Additional general design parameters for this embodiment useful for various flow rates include the following. For total flow rate between 20 μL/min and 50 μL/min, L is between 15 cm and 40 cm, and d is between 50 μm and 200 μm. Preferably, L is between 15 cm and 40 cm, and d is between 75 μm and 150 um. More preferably, L between 15 cm and 40 cm, and d is between 75 μm and 125 μm.

For total flow rate between 5 μL/min and 20 μL/min, L is between 4 cm and 20 cm, and d is between 50 μm and 200 μm. Preferably L is between 4 cm and 20 cm and d is between 75 μm and 150 μm, and more preferably L is between 4 cm and 20 cm and d is between 75 μm and 125 μm.

For total flow rate between 500 mL/min and 5 μL/min, L is between 4 mm and 4 cm; d is between 25 μm and 200 μm. Preferably L is between 4 mm and 4 cm and d is between 50 μm and 150 μm, and more preferably L is between 4 mm and 4 cm and d is between 50 μm and 100 μm.

For total flow rates of 500 mL/min or less, L is between 1 mm and 5 mm and d is between 25 μm and 200 μm. Preferably L is between 1 mm and 5 mm and d is between 50 μm and 150 μm, and more preferably L is between 1 mm and 5 mm and d is between 50 μm and 100 μm.

More than one mixer of this or other embodiments may be connected together by providing the output of a first mixer to an input to the second mixer.

Conduit Shape Considerations

It is well-known to one skilled in the art that mixing in a laminar flow is less effective in conduits having cross sectional shapes that include acute or right corners or ones that are of high aspect ratio (e.g. a conduit having a large ratio of width to depth). U.S. Pat. Nos. 5,716,852, 5,972,710 and 6,007,775 take advantage of this effect. To this end the most preferable shape is a circular cross-section. It is also well known to one skilled in the art that curvature of a conduit along its length introduces additional axial dispersion hence additional time-blur. To this end the preferred shape is a conduit having large radius of curvature and the most preferred shape is a straight conduit. It is also well known to one skilled in the art that a change of area or cross sectional shape introduces additional axial dispersion hence additional time-blur. To this end the preferred shape of the conduit is one having a constant cross sectional area and shape along its length.

As fluid flow rate is increased, the mixer design may be adjusted to maintain conditions of minimal blur and maximal mixing speed under reasonable operating conditions. Consider a flow rate of 1 mL/min (typical for conventional HPLC with 4.6 mm diameter separation columns). The required mixer length is 4.2 meters. To achieve a blur time of 0.3 seconds one needs a mixer diameter of 0.05 mm; however, the pressure drop would be about 58,400 psi, which clearly is impractical with existing pumping technologies and materials. Alternatively, to achieve a pressure drop of about 10 psi requires a diameter of about 0.44 mm but then the blur time would be about 40 seconds and thus limit the device to applications where the gradient time is longer than about 10 minutes.

Design and Fabrication of Coaxial Mixer Embodiments

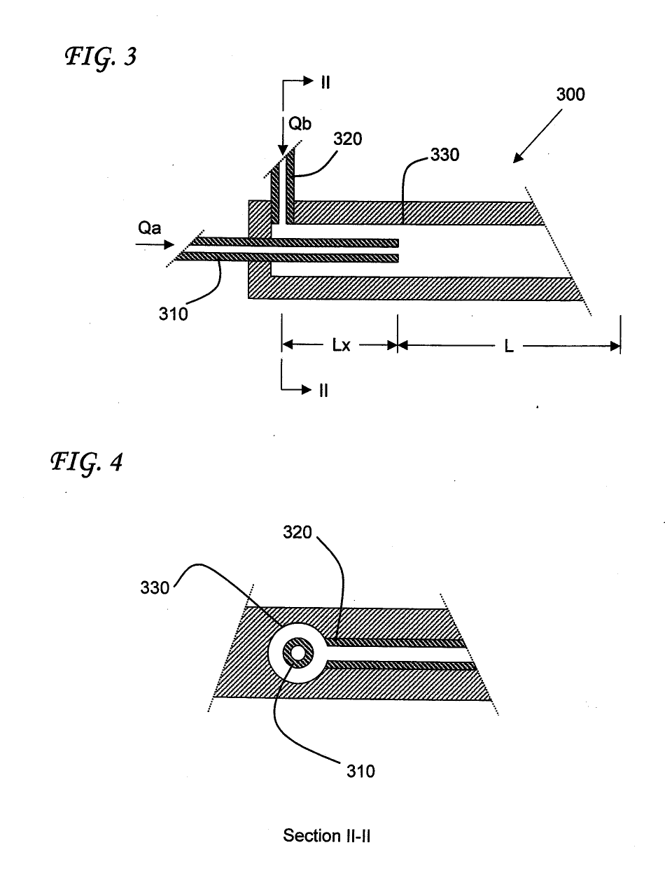

When using microfabrication methods to make the mixer, one can obtain mixer designs that offer further advantages. FIGS. 3 and 4 show a mixer, 300, in accordance with another embodiment of the invention. Input conduits 310 and 320 supply first and second fluids, respectively. Conduit 310 is arranged coaxially at the input of mixing conduit 330 and extends some distance, Lx, into conduit 330. Conduit 320 is connected laterally at the input of mixing conduit 330. The length, L, of mixing conduit 330 beyond the termination of conduit 310 is selected to be at least one-eighth the total flow rate divided by the diffusion coefficient, or Q/8D. Note that this use of a coaxial geometry to mix the two fluids reduces the required length of the mixing conduit by a factor of two. In operation, one fluid enters the mixing region from input conduit 310 (i.e., as a solid cylindrical column along the axis) while the second fluid enters the mixing region from the annular region around 310 (i.e., as a hollow cylindrical column of fluid near the wall). The inside hydraulic diameters of conduits 310, 320 and 330 are d1, d2 and d3, respectively. Preferably conduit 330 has a circular cross-sectional shape. The length, Lx, is preferably 3 to 10 times the hydraulic diameter associated with the gap between the outside of 310 and the inside of 330.

Device 300 can be constructed using a combination of a capillary for conduit 310 that is inserted and sealed into a machined or etched planar ‘chip’ similar to that used in the co-owned U.S. patent application Ser. No. 10/410,313 titled “Microfluidic Detection Device Having Reduced Dispersion and Method for Making the Same” by Cyr, Farrow, and Arnold.

General design parameters for this embodiment useful for various flow rates include the following. For total flow rate between 20 μL/min and 50 μ.L/min, L is between 5 cm and 14 cm, and d is between 85 μm and 350 μm. Preferably, L is between 5 cm and 14 cm, and d is between 85 μm and 250 um. More preferably, L between 5 cm and 14 cm, and d is between 100 μm and 200 μm.

For total flow rate between 5 μL/min and 20 .μL/min, L is between 1 cm and 6 cm, and d is between 85 μm and 350 .μm. Preferably L is between 1 cm and 6 cm and d is between 85 μm and 250 μm, and more preferably L is between 1 cm and 6 cm and d is between 100 μm and 200 .μm.

For total flow rate between 500 mL/min and 5 μL/min, L is between 1 mm and 1.5 cm; d is between 50 .μm and 350 μm. Preferably L is between 1 mm and 1.5 cm and d is between 50 μm and 250 μm, and more preferably L is between 1 mm and 1.5 cm and d is between 85 μm and 150 μm.

More than one mixer of this or other embodiments may be connected together by providing the output of a first mixer to an input to the second mixer.

Design and Fabrication of Mixers for High-Flow Applications

A preferred embodiment for mixing two or more fluid streams mixing at a combined flow rate >50 microliters/min is illustrated in FIG. 2. FIG. 2 illustrates a mixer, 200 the invention suitable for use at higher flow rates wherein the flow of fluid from each fluid source is divided into N sub-streams prior to mixing. Conduits 210 and 220 carry first and second fluids, respectively. Each conduit is split into bundles of sub-streams 240 and 245, respectively, each of which has N sub-conduits. Preferably the transit time through each sub-conduit is about equal (e.g., the diameters and length of each element of bundle 240 are about equal and the diameters and lengths of each element of bundle 245 are about equal). All of the sub-conduits are brought together to form a composite bundle 250 at the inlet of the mixing section 230. The arrangement in the composite bundle can be random but preferably the arrangement is in the form of an alternating array as shown in FIG. 2a, wherein elements from the first substream, 260, are in a regular, alternating arrangement with elements from the second substream, 265. The length of the mixing section, L, is selected to be about “B” times one-eighth the total flow rate through the mixer divided by the binary diffusion coefficient and also divided by N-squared (for the case of an alternating array bundle) or by a value between N and N-squared for a random array bundle. As stated above, B is a numerical factor greater than or equal to unity. A value of B=1 corresponds to a degree of mixing of about 99% and a value of B=2 corresponds to a degree of mixing of about 99.99%. More than one mixer of this or other embodiments may be connected together by providing the output of a first mixer to an input to the second mixer.

Connections to and Fabrication of Mixers

The connections into and out of the mixer are preferably made using low dead-volume fittings or joints of the type typically used in HPLC systems. For example a ‘low flow rate’ mixer, 100, using single sub-streams, can employ standard low-dead-volume HPLC ‘T’ or ‘Y’ fittings at the mixer inputs 110, 120, and a standard low-dead-volume HPLC union fitting at the outlet, 130. Preferably, the mixing conduit is chosen to have a cross-sectional area that is larger than the cross sectional area of the smaller input conduit and smaller than the sum of the cross sectional areas of the input conduits.

A ‘high flow rate’ mixer, 200, using N sub-streams, could, for example, be constructed as shown in FIG. 2. The first and second supply conduits, 210, 220 are each connected to N sub-conduits, 240, 245. These 2N sub-conduits are formed into a bundle that is connected to the mixer inlet. Examples of the possible means for making the connections are illustrated in the following examples.

1) Consider sub-conduits that are polyimide-jacketed silica capillaries. The bundle of capillaries is inserted in a polymer jacket (e.g., a PEEK jacket) and the assembly is injected with a suitable epoxy resin. The end face may be finished using a wire saw. The assembly then may be used with a standard ferrule-type HPLC fitting.

2) Consider supply conduits and sub-conduits that are stainless steel tubing. The inside diameter of the supply conduit and the outside diameter of the sub-conduits are selected so that the bundle of sub-conduits may be inserted within the supply conduit. The sub-conduits may then fixed be within the supply conduit using furnace brazing with an appropriate braze alloy (i.e., one that is chemically compatible with the fluid intended to flow through the system).

System Design Considerations in Relation to HPLC Pumping Technology

The most common HPLC pump is a positive displacement piston-type pump where the piston is driven by a screw shaft or by an eccentric cam. This type of drive produces undesirable pulsations that are reduced by adding a hydraulic damper at the pump outlet. Obviously formation of a gradient requires a time variation in pump flow rate and the time-scale of this variation must be long compared to the damper time constant. To this end, for fast gradient generation it is preferable to use a completely non-damped liquid supply, for example the types of high pressure flow controllers described by Paul et al. e.g., co-owned U.S. Pub. No. 2002/0189947, Neyer et al. 2002/0195344, Paul et al. 2003/0052007, Paul et al. WO 2004/027535 and Neyer et al. WO 02/101474.

HPLC pumping systems typically operate at flowrates of about 1 μL/min. The flow rates required to perform capillary or nanobore HPLC typically are less than 0.01 mL/min and may be as small as 50 mL/min. The common method used to reach these flow rate is to split off a substantially portion of the liquid flow from a positive displacement pump. The ‘splitter’ is analogous to an electrical resistive divider (i.e. pressure is analogous to voltage and flow rate is analogous to current). The conductance (inverse resistance) of a flow element (e.g., a separation column) scales inversely with the liquid viscosity. The gradient represents a time variation in liquid composition hence a time variation in viscosity. To achieve a constant split ratio for a time varying composition input, the average viscosity along the length of the column matches the average viscosity along the length of the splitter. This matching is easily achieved for slow gradients, that is, for gradient times that are more than about 50 times longer than the flow transit time through the column. For fast gradients this matching is difficult if not impossible to achieve. The issue of splitter matching is avoided by using direct low flow rate pumping, for example using a high-pressure flow controller of the types described by Paul et al. e.g., co-owned U.S. Pub. No. 2002/0189947, Neyer et al. 2002/0195344, Paul et al. 2003/0052007, Paul et al. WO 2004/027535 and Neyer et al. WO 02/101474.

The liquid supplied to the column preferably is well-mixed for optimized separation results, and this generally is achieved using a mixing component. The residence time in the mixer preferably is short compared to the time of the gradient to avoid mixing early portions of the gradient with later portions of the gradient. Gradient generation is achieved by combining the pumping liquids at correct proportions and assuring that the liquids are adequately mixed.

Given—d-diameter of mixer, D-Diffusion coefficient, .τ_{fil}=time of filtering, τₘᵢₓ=time of mixing, Q=flow rate, τ_{gradient}=duration of gradient, τᵣᵤₙ=total separation time. We define a parameter α., where τ_{gradient}=α*τᵣᵤₙ, the relevant design considerations are:

As described for low flow mixer embodiments, the minimum length of the mixing conduit used to achieve effective mixing is L=BQ/8D.

Given a desired transit time through the mixer, we can decide upon a diameter d=[(16Dτₘᵢₓ)/(πα))].^{1/2} for the mixer in the case of a pulseless pump source.

Acceptable control of the pulsation effects will be achieved if the diameter is chosen to be d=[(16*3*D*τ_{fil})/(π*(α)^{1/-2}))]^{1/2}

If we assume:

For τ_{gradient}t=α*τ_{.run} 0.5<α.<1—the most limiting case for pulsation control is the short-time limit (α=0.5). This value is used to continue derivations.

To optimize throughput, we target τᵣᵤₙ<˜0.5 minutes for this mixer-driven system.

From this set of criteria, we observe that:

Generally, the observed fluctuations are produced by the finite time steps between pump adjustments. In the case of direct drive pumps, this translates into the time between stepper motor steps; for feedback-controlled pumps, the relevant time is the servo loop time. Ideally, one would like to have as many steps as possible during the course of a controlled gradient generation so that the composition changes in a smooth fashion. However, high gradient ramp rates (i.e., <2 minutes; especially at low flow rates (<5 μL/min)), the ability to vary the flow rate smoothly becomes limited by the size of the step that can be generated or by the servo loop time.

Example for a servo-loop system: If the servo loop time is on the order of one second and the gradient is to be ramped from pure water to pure acetonitrile in 30 seconds, there will be .about.30 adjustments. In this example, the steps in composition at the mixing point will be ˜3% of the gradient ramp—a very noticeable percentage. Ideally, the step sizes are infinitesimally small. Practically, a smooth gradient is generated using step sizes that preferably are not more than 0.1% of the gradient ramp.

As an example for a direct drive system, if the step size for the pumps are on the order of 10 nL, the combined flow rate is 500 nL/min and the 0-100% gradient is to occur over 1 minute, the step sizes in composition will be 2% of the gradient. This can produce noticeable and detectable mixing noise. In such cases, it is preferable to enlarge the diameter of the mixer according to the prescription given in paragraph 86.

Note that for direct drive pumps, the detrimental effects increase as flow rates decrease because the step size represents a fixed volumetric displacement. As the flow rate decreases, this displacement represents a larger fraction of the overall flow rate. If the minimum step size is 10 nL and the total flow rate is 50 nL/min, the pump will generate less than 1 pulse of liquid per second.

These fluctuations can degrade system performance by reducing separation capacity and by producing noise in detector output by generating signal oscillations if the detector is sensitive to changes in refractive index.

Damping of Pulsations

In both the lower and higher flow rate embodiments, the issue of pump pulsation may be addressed in the design and operation of the device. To remove oscillations, the diameter of the mixing device is adjusted so that the Taylor-Aris dispersion (described above) is sufficient to blur out high-frequency oscillations in the mixed-fluid composition. There are several considerations to take into account, depending upon the flow rate for which the mixing must be accomplished. As stated above:

1. The required mixing length is determined to be Lₘᵢₓ=BQ/8D

2. The blur time is given as τ_{blur}=d²/8D

3. The transit time through the mixer is given as τₜᵣₐₙₛᵢₜ=[(π./4)*d²]/4D that has the same dependencies on device parameters and is near equal to the blur time given immediately above

4. The pressure drop across the mixer is given by ΔP=4D/[(d⁴/32μ.)*(π/4)]

The goal is to adjust the blur time of the mixer to be longer than the pulsation time by an amount that is sufficient to reduce the pulsations to acceptable levels. For example, assume the case of a low flow rate (<50 μL/min) mixer. Once the flow rate for the system is selected, the mixing length is given by (1) above. Once the pulsation time of the pump is determined, the blur time set, by selecting diameter d, to remove the pulsation (for example, τ_{blur}>2 τₚᵤₗₛₐₜᵢₒₙ). From the value of d, one can determine if the transit time (3) and the pressure drop across the mixer (4) are acceptable for overall system performance. If not, the process is iterated or the design is changed to that used for higher flow rate mixers.

Further Uses for Low Time-Dispersion Mixing Devices

The utility of low time-dispersion mixing devices extends beyond fast gradient generation for HPLC. Rapid mixing devices can be used to enhance the performance of detection systems. In some cases, it is desirable to add and mix materials to a fluid eluting from a separation column, prior to detection. For example, this may be done to perform post-column molecular labeling with rapidly reacting fluorescent or electrochemically-active labels and also to add matrix material prior to deposition on a MALDI (matrix assisted laser desorption ionization) plate for subsequent analysis by mass spectrometry. In each case, the addition and mixing must be done with a minimum of dispersion to maintain chromatographic resolution. The methods and devices of the present invention are equally useful for these applications. International publication WO 02/062475 describes in greater detail configurations and methods for MALDI target deposition in which the output of a mixer is sent to a dispenser and the dispenser output it meted onto a MALDI plate.

To further maintain chromatographic resolution it is preferable that the mixing element and the connections to the mixing element not add geometric dispersion. Geometric dispersion results when material follows flow paths of differing lengths traveling at different speeds. To this end it is preferable to use a ‘Y’ type connector rather than a ‘T’ type connector for mixing two single sub-streams. In the case that the connector is microfabricated, the intersection should be Y-shape contoured, rather than having a right-angle T-intersection, such that all volumes are evenly swept to provide uniform rapid mixing. It is more preferable to use the coaxial arrangement of FIG. 3 where the effluent from the chromatographic column is input on along the centerline of the mixing conduit (i.e. input via conduit 310 in FIG. 3).

Clearly, this concept can be extended to include ternary, quaternary or higher order gradient mixing by simple extension of the concept to include three, four or more input fluid streams.

The mixing device can also provide advantage in chemical microreactor applications where mixing times must be rapid to be applicable for rapid reactions.

While the application is very different, and the operational flow rates are very different, device 300 also has utility as a micro cytometry device when the flow rates are increased to the point where the linear flow velocity of the fluid is very high. In this case, the transit time through the device is short relative to the mixing time, allowing one to provide a two-phase minimally mixed fluid flow through a channel in a detection region. In this application, the outer fluid is known as the sheath flow and is introduced via the sidearm. The fluid introduced in the upstream end of the device contains sample (particles, cells, etc.). By introducing the sheath flow at a much higher rate one can accomplish focusing of the sample and provide a narrow position distribution of the particles in the stream along the central axis where optical detection would be accomplished prior to exiting through the downstream fluidic connection. Additional ports may be added in the region of detection for insertion of optical fibers that are used for insertion and collection of the light for detection. In the design of this embodiment the dimensions are confined such that minimal mixing occurs in the region where the fluid come together.

### EXAMPLES

Below are examples of specific embodiments for carrying out the present invention. The examples are offered for illustrative purposes only, and are not intended to limit the scope of the present invention in any way. Efforts have been made to ensure accuracy with respect to numbers used (e.g., amounts, temperatures, etc.), but some experimental error and deviation should, of course, be allowed for.

### Example 1

### Low-Flow Rate Mixer

Consider a round conduit having a diameter, d, of 0.05 mm, a total flow rate, Q, of 10 microliters per minute and a diffusion coefficient, D, of 10⁻⁹ m²/s (a value typical of water diffusing into water). According to the prescription above, the length, L, of the mixing conduit is preferably taken to be greater than BQ/8D corresponding to about 4.2 cm. The volume of the conduit having this length is about 0.082 microliters and the flow delay time is about 0.5 seconds. The one-on-e full width time blur is about d²/8D (about 0.32 seconds for the example parameters provided).

The example just given shows a mixer with a high degree of mixing that is suitable for gradient times as fast as 5 to 10 seconds. The pressure drop through this mixer at the example flow rate is about 5.5 psi which favorably compares to typical pressure drops of 500 to 2000 psi through a separation column.

### Example 2

### High-Flow Rate Mixer

Consider a round conduit having a diameter, d, of 0.05 mm, a total flow rate, Q, of 1 mL/min and a diffusion coefficient, D, of 10⁻⁹ m²/s (a value typical of water diffusing into water), N=10 and an alternating array bundle. The length, L, of the mixing conduit is on the order of about 4.2 cm. It will be appreciated that the issues of delay time and of axial dispersion that give rise to time-blur begin at the point of mixing. Using sub-divided input streams results in a substantial reduction of the mixing conduit length, L, and concomitant reductions in delay time and time blur.

While the invention has been particularly shown and described with reference to a preferred embodiment and various alternate embodiments, it will be understood by persons skilled in the relevant art that various changes in form and details can be made therein without departing from the spirit and scope of the invention.

All references, issued patents and patent applications cited within the body of the instant specification are hereby incorporated by reference in their entirety, for all purposes.

1. The fluid mixer of claim 65 wherein 1 mm≦L≦40 cm and 25 μm≦d≦200 μm, and wherein said outlet is adapted for connection to a downstream element.

2. The fluid mixer of claim 1, wherein said downstream element is selected from the group consisting of a sample injector, a chromatography column, a detector, a second fluid mixer, a reactant collector, a product collector, and a matrix assisted laser desorption ionization (MALDI) plate.

3. The fluid mixer of claim 1, wherein 1 mm≦L≦5 mm and 25 μm≦d≦200 μm.

4. (canceled)

5. (canceled)

6. (canceled)

7. (canceled)

8. The fluid mixer of claim 1, wherein 4 mm≦L≦4 mm and 50 μm≦d≦100 μm.

9. (canceled)

10. (canceled)

11. (canceled)

12. (canceled)

13. (canceled)

14. The fluid mixer of claim 1, wherein 15 cm≦L≦40 cm and 75 μm≦d≦125 μm.

15. (canceled)

16. The fluid mixer of claim 2, wherein said downstream element is a chromatography column.

17. The fluid mixer of claim 2, wherein said downstream element is a second fluid mixer.

18. (canceled)

19. (canceled)

20. The fluid mixer of claim 2, wherein said downstream element is a detector.

21. The fluid mixer of claim 2, wherein said downstream element is a matrix assisted laser desorption ionization (MALDI) plate.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. The method of claim 73 wherein the volume of said mixing conduit is ≦15 μL, and wherein said fluids passing through said mixing conduit achieve ≧90% complete transverse mixing.

48. (canceled)

49. (canceled)

50. (canceled)

51. (canceled)

52. The fluid mixer of claim 65, wherein the volume of said mixing conduit is ≦1 μL.

53. The method of claim 73, wherein the first and second fluids pass through said mixing conduit and achieve ≧99% complete transverse mixing.

54. (canceled)

55. (canceled)

56. The method of claim 73, further comprising selecting a manifold interposed between said first and second inputs and said mixing conduit, wherein said fluids are brought into contact by the manifold prior to entering said mixing conduit.

57. (canceled)

58. (canceled)

59. (canceled)

60. (canceled)

61. (canceled)

62. (canceled)

63. (canceled)

64. (canceled)

65. A fluid mixer, comprising:
a mixing conduit having an inlet and an outlet, a length, L, and a diameter d;
a first input comprising a first plurality of sub-conduits and adapted to receive a first fluid;
a second input comprising a second plurality of sub-conduits and adapted to receive a second fluid
wherein said first plurality of sub-conduits and said second plurality of sub-conduits form a composite bundle of sub-conduits having an outlet, said composite bundle outlet in communication with said mixing conduit inlet.

66. The mixer of claim 65, wherein said composite bundle is an alternating array of said first plurality of sub-conduits and said second plurality of sub-conduits.

67. The mixer of claim 65, wherein said composite bundle is an irregular array of said first plurality of sub-conduits and said second plurality of sub-conduits.

68. The method of claim 73, wherein there are N sub-conduits within said first plurality of sub-conduits and wherein, L is greater than BQ/8DN², wherein B≧1.

69. The method of claim 68, wherein B≦2.

70. The fluid mixer of claim 65, further comprising a second composite bundle of sub-conduits having an outlet, said outlet of said second composite bundle of sub-conduits in communication with said first input.

71. The fluid mixer of claim 70, wherein said second composite bundle of sub-conduits is an alternating array.

72. The fluid mixer of claim 71, wherein said second composite bundle of sub-conduits is an irregular array.

73. A method for mixing fluids, comprising:
selecting a mixing conduit having an inlet end and an outlet, a length L and a diameter d;
introducing a first fluid to the mixing conduit through a first input comprising a first plurality of sub-conduits that are co-axially oriented with respect to, and extend from said inlet end of said mixing conduit;
introducing a second fluid to the mixing conduit through a second input comprising a second plurality of sub-conduits laterally oriented with respect to said mixing conduit.

74. The method of claim 86, wherein said mixing conduit has a circular cross-section, and said distance Lₓ is from 3 to 10 times the hydraulic diameter associated with a gap between the outside of said first input conduit and the inside of said mixing conduit.

75. The method of claim 86, wherein Q ranges from 0.5 μL/min to 50 μL/min and D ranges from 0.2×10⁹ m²/sec to 5×10⁻⁹ m²/sec.

76. The method of claim 74, wherein 1 mm≦L≦14 cm, and 50 μm≦d≦350 μm.

77. The method of claim 76, wherein 1 mm≦L≦1.5 cm, and 50 μm≦d≦350 μm.

78. The method of claim 77, wherein 1 mm≦L≦1.5 cm, and 50 μm≦d≦250 μm.

79. The method of claim 78, wherein 1 mm≦L≦14 cm, and 85 μm≦d≦150 μm.

80. The method of claim 76, wherein 1 cm≦L≦6 cm, and 85 μm≦d≦350 μm.

81. The method of claim 80, wherein 1 cm≦L≦6 cm, and 85 μm≦d≦250 μm.

82. The method of claim 81, wherein 1 cm≦L≦6 cm, and 100 μm≦d≦200 μm.

83. The method of claim 76, wherein 1 cm≦L≦14 cm, and 85 μm≦d≦350 μm.

84. The method of claim 83, wherein 5 cm≦L≦14 cm, and 85 μm≦d≦250 μm.

85. The method of claim 84, wherein 5 cm≦L≦14 cm, and 100 μm≦d≦200 μm.

86. The method of claim 73 wherein the flow rate through the mixing conduit is Q, the binary diffusion coefficient the first and second fluids is D, the mixing conduit outlet is located at length Lₓ beyond the end of the first input, and Lₓ, is greater than Q/8D.
